(19) United States
(12) Patent Application Publication
(10) Pub. No.: US 2026/0143205 A1
(43) Pub. Date: May 21, 2026

(54) INFORMATION PROCESSING APPARATUS AND RECORDING MEDIUM

(71) Applicant: AlphaTheta Corporation, Kanagawa (JP)

(72) Inventors: Masahiro KONDO, Kanagawa (JP); Yuki MURATA, Kanagawa (JP)

(21) Appl. No.: 19/393,083

(22) Filed: Nov. 18, 2025

(30) Foreign Application Priority Data
Nov. 19, 2024 (JP) 2024-201592

(51) Int. Cl. H04N 21/81

(52) U.S. Cl. CPC H04N 21/8113

(57) ABSTRACT

An information processing apparatus includes a processor configured to: display, on a display, an operation screen including: a music editing screen for editing music; and a playback control screen for controlling a playback condition of music; edit music in accordance with an operation to the music editing screen; play music edited through the music editing screen under a playback condition of the playback control screen; and capture a moving image containing the edited music as audio while playing the edited music.

### CROSS-REFERENCE TO RELATED APPLICATION

The present application claims priority to and incorporates by reference the entire contents of Japanese Patent Application No. 2024-201592 filed in Japan on November 19, 2024.

### BACKGROUND OF THE INVENTION

### 1. Field of the Invention

The present invention relates to an information processing apparatus and a music playback program.

### 2. Description of the Related Art

Moving-image capturing has been conventionally performed in which music is played back, sound is output by a speaker, a headphone, or the like, and a dance is performed in accordance therewith (for example, Japanese Laid-open Patent Publication No. 2015-032846).

Incidentally, a user involved in a dance, such as a dancer, may edit music to make the music suitable for a dance. For example, the user may add an effect to the music, or change the length of the music. Furthermore, when practicing a dance in accordance with music, the user involved in a dance may desire to change the tempo of the music, play back the music from a specific part of the music, and repeatedly play back a specific part. Furthermore, the user involved in a dance may capture a moving image of his/her dancing in accordance with music, check the captured moving image, and repeat reviewing the choreography of the dance and editing the music, as necessary.

Edit software for editing music has been separated from capturing software for capturing a moving image. Therefore, for example, when capturing a moving image of the user involved in a dance dancing in accordance with music edited by edit software, the user exports and stores the edited music as audio data in a predetermined an audio file format by using edit software, and captures a moving image by using capturing software while playing back the stored audio data, which takes time and effort.

### SUMMARY OF THE INVENTION

It is an object of the present invention to at least partially solve the problems in the conventional technology.

According to one aspect of an embodiment, an information processing apparatus includes a processor configured to: display, on a display, an operation screen including: a music editing screen for editing music; and a playback control screen for controlling a playback condition of music; edit music in accordance with an operation to the music editing screen; play music edited through the music editing screen under a playback condition of the playback control screen; and capture a moving image containing music as audio while playing the edited music.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 illustrates a functional configuration example of an information processing apparatus according to an embodiment;

FIG. 2A illustrates an example of a music editing screen according to the embodiment;

FIG. 2B illustrates an example of the music editing screen according to the embodiment;

FIG. 3A illustrates an example of an advance mode screen according to the embodiment;

FIG. 3B illustrates an example of the advance mode screen according to the embodiment;

FIG. 4A illustrates an example of a basic mode screen according to the embodiment;

FIG. 4B illustrates an example of the basic mode screen according to the embodiment;

FIG. 4C illustrates an example of the basic mode screen according to the embodiment;

FIG. 5 illustrates an example of a moving-image capturing screen according to the embodiment;

FIG. 6A illustrates an example of a flow in which a user edits music and captures a moving image;

FIG. 6B illustrates an example of a flow in which a user edits music and captures a moving image;

FIG. 7 is a flowchart illustrating an example of a procedure of control processing including music playback processing according to the embodiment;

FIG. 8 is a block diagram illustrating a functional configuration example of an information processing apparatus according to embodiments; and

FIG. 9 illustrates a hardware configuration example.

### DETAILED DESCRIPTION OF THE PREFERRED EMBODIMENTS

Embodiments for carrying out an information processing apparatus and a music playback program (hereinafter, referred to as "embodiments") according to the present disclosure will be described below with reference to accompanying drawings. Note that the embodiments merely illustrate one example or one aspect. The following description does not limit the configuration, effect, function, property, characteristics, method, application, and the like according to the present disclosure.

### First Embodiment

### Configuration of Information Processing Apparatus 10

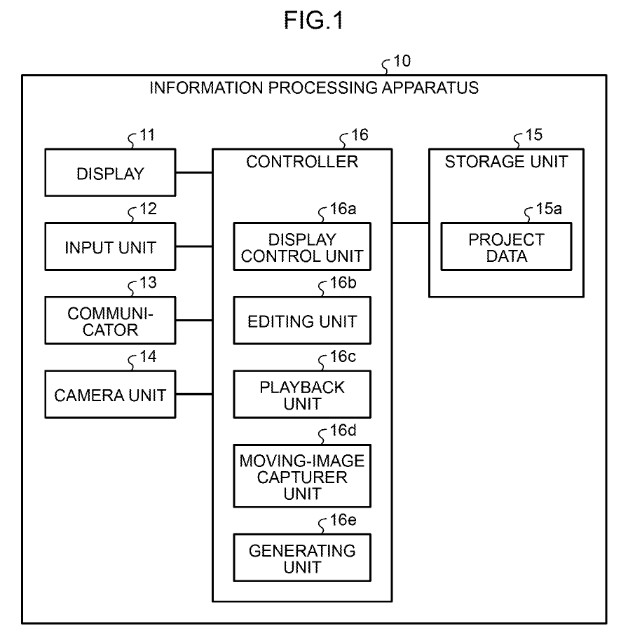

FIG. 1 illustrates a functional configuration example of an information processing apparatus 10 according to an embodiment. For example, the information processing apparatus 10 is a user terminal in which music editing/moving-image capturing software is installed, for example, a mobile terminal such as a smartphone. The information processing apparatus 10 has an edit function of editing music, a playback control function of playing back music, and a moving-image capturing function of capturing a moving image. FIG. 1 schematically illustrates blocks related to the edit function, the playback control function, and the moving-image capturing function of the information processing apparatus 10. As illustrated in FIG. 1, the information processing apparatus 10 includes a display 11, an input unit 12, a communicator 13, a camera unit 14, a storage unit 15, and a controller 16. Note that FIG. 1 merely and selectively illustrates functional units related to the above-described music playback function. The information processing apparatus 10 may include a functional unit other than those illustrated.

The display 11 is a functional unit that displays various types of information. In an example, a liquid crystal display and an organic electro luminescence (EL) display implement the display 11. For example, the display 11 displays various operation screens related to the edit function, the playback control function, and the moving-image capturing function.

The input unit 12 is a functional unit that inputs various operations. When a mobile terminal implements the information processing apparatus 10, the display 11 and the input unit 12 are integrated, and implemented as a touch panel. For example, the input unit 12 receives various inputs to various operation screens displayed on the display 11.

The communicator 13 is a functional unit that is connected by wire or wirelessly to a network (not illustrated), and that transmits and receives information to and from another device and the like. In an example, a communication module or a network interface card (NIC) implements the communicator 13.

The camera unit 14 is a functional unit that captures an image. For example, the camera unit 14 incorporates an imaging element, captures an image with the imaging element, and outputs image data of the captured image.

The storage unit 15 is a functional unit that stores various types of data. In one aspect, a semiconductor memory element, such as a random access memory (RAM) and a flash memory, or a storage implements the storage unit 15. For example, the storage unit 15 stores project data 15a.

The information processing apparatus 10 can edit music through the edit function, and manages the music as a project. The project data 15a is obtained by storing music edited through the edit function.

The controller 16 is a functional unit that entirely controls the information processing apparatus 10. For example, a hardware processor can implement the controller 16. As illustrated in FIG. 1, the controller 16 includes a display control unit 16a, an editing unit 16b, a playback unit 16c, a moving-image capturer unit 16d, and a generating unit 16e. Note that the controller 16 is not prevented from being implemented by a hard-wired logic.

The display control unit 16a performs control of displaying various types of information on the display 11. For example, the display control unit 16a displays, on the display 11, an operation screen including a music editing screen and a playback control screen.

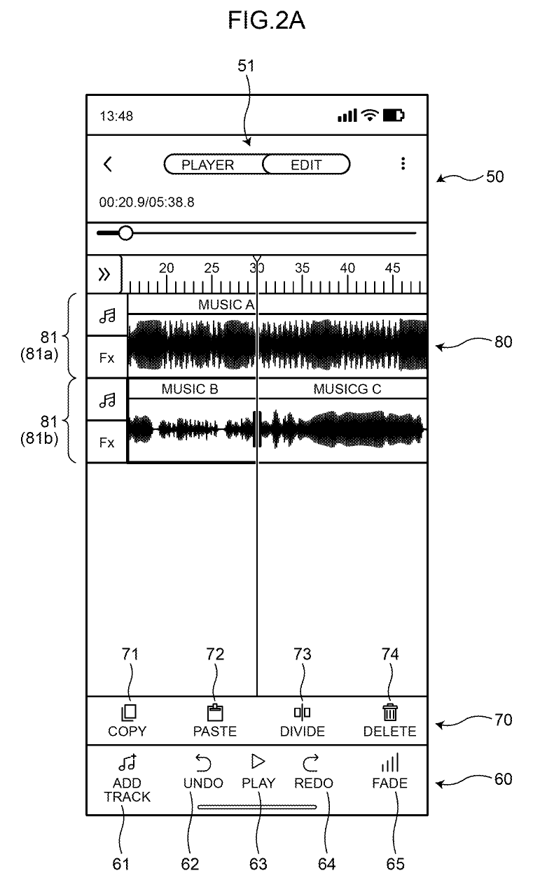

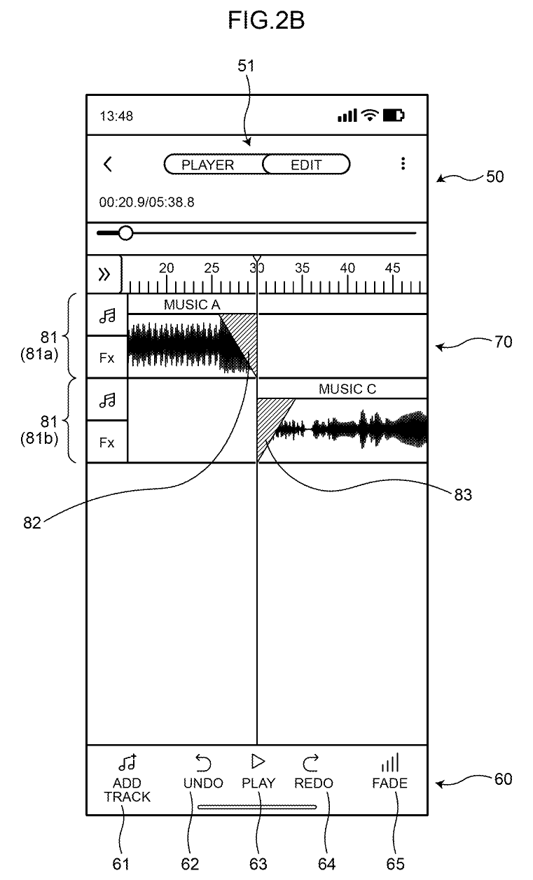

An example of the music editing screen and the playback control screen displayed on the display 11 will be described here. An example of the music editing screen will be described first. FIGS. 2A and 2B illustrate an example of a music editing screen 50 according to the embodiment.

The music editing screen 50 includes a switching control 51, a footer 60, an edit operator 70, and a track display 80.

In the switching control 51, "PLAYER" and "EDIT" are displayed, and can be selected. When "PLAYER" is selected, a playback control screen to be described later is displayed. When "EDIT" is selected, the music editing screen 50 is displayed.

The footer 60 includes a track addition button 61, an undo button 62, a play/stop button 63, a redo button 64, and a fade button 65.

The track addition button 61 is a button for giving an instruction to add a track 81 to the track display 80. The undo button 62 is a button for giving an instruction to cancel the last action to return the state to the state before the last action has been done. The play/stop button 63 is a button for giving an instruction to play back and stop playback of music being edited. In the play/stop button 63, "PLAY" is displayed in a non-playback state in which no music is played back, and "STOP" is displayed during playback of music. The redo button 64 is a button for giving an instruction to redo the last action that has been canceled by the undo button 62. The fade button 65 is a button for giving an instruction to add a fade effect to music.

The edit operator 70 includes a copy button 71, a paste button 72, a divide button 73, and a delete button 74. The edit operator 70 is displayed when a touch operation is performed on music displayed on the track 81.

The copy button 71 is a button for giving an instruction to copy music. The paste button 72 is a button for giving an instruction to paste music copied through the copy button 71. The divide button 73 is a button for giving an instruction to divide music at a designated position. The delete button 74 is a button for giving an instruction to delete a designated music.

The music editing screen 50 manages a sound source to be used for music through the track 81. A track 81 is added to the track display 80 by a touch operation to the track addition button 61. The track display 80 displays the track 81.

One or a plurality of pieces of music, which are to serve as sound sources, is registered in the track 81. For example, web service that provides music via a network (not illustrated) is accessed, and music designated by a user is downloaded and registered in the track 81. In the track 81, an audio waveform indicating a change in audio of music is displayed along a timeline of the registered music.

Music registered in each track 81 can be edited through the copy button 71, the paste button 72, the divide button 73, and the delete button 74 of the edit operator 70. For example, when a touch operation is performed, the edit operator 70 can perform operations of copying, pasting, dividing, and deleting the music registered in the track 81. The music is edited by combining the operations. For example, the length of music can be changed by performing edit of cutting out and extracting a part of c registered in the track 81.

Furthermore, edit of adding an effect to music can be performed in each track 81. For example, when a touch operation is performed, fade-in and fade-out can be added through the fade button 65 in music registered in the track 81. Fade-in is a gradual increase in volume. Fade-out is a gradual decrease in volume. The fade effect can be used (1) when it is desired to gradually increase the volume, (2) when it is desired to connect two pieces of music without a feeling of strangeness, and (3) when it is desired to gradually end a piece of music. For example, (1) when it is desired to gradually increase the volume, fade-in is set. (2) When it is desired to connect two pieces of music without a feeling of strangeness, fade-out is set to a preceding music, and fade-in is set to a succeeding music. (3) When it is desired to gradually end a piece of music, fade-out is set. When an effect is added to music, a mark indicating the added effect is displayed on the track 81. Furthermore, edit of adjusting volume balance, a tone, and the like can be performed in each track 81. For example, in the track 81, when a predetermined operation is performed after a touch operation, a sub-screen for designating the maximum volume is displayed, and the maximum volume can be adjusted.

In the music editing screen 50, edit of connecting a plurality of pieces of music together can be performed by registering the plurality of pieces of music in one or a plurality of tracks 81 and editing each of the registered plurality of pieces of music. Furthermore, in the music editing screen 50, edit of mixing a plurality of pieces of music can be performed by registering the plurality of pieces of music in the plurality of tracks 81.

FIG. 2A illustrates two tracks 81a and 81b on the music editing screen 50. Music A is registered in the track 81a. A part of music B and a part of a succeeding music C are registered in the track 81b.

FIG. 2B illustrates an example of a result obtained by editing the plurality of pieces of music in the tracks 81a and 81b in FIG. 2A and adding an effect. FIG. 2B illustrates a case where a part of the music A in the track 81a is extracted, the music B is deleted from the track 81b, and the extracted part of the music A in the track 81a is connected with the music C in the track 81b. Furthermore, in FIG. 2B, an effect of fading out after selecting a start point and an end point is added at the end of the music A in the track 81a. A triangular mark 82 is displayed in the music A in the track 81a. The mark 82 indicates fade-out in accordance with the position of the start point to the end point of the fade-out. Furthermore, an effect of fading in after selecting a start point and an end point of the music C in the track 81b is added. A triangular mark 83 is displayed in the music C in the track 81b. The mark 83 indicates fade-in in accordance with the position of the start point to the end point of the fade-in. The hypotenuses of the triangular marks 82 and 83 represent changes in volume levels.

The information processing apparatus 10 can play back the music edited through the music editing screen 50 in the playback control screen by switching the switching control 51 on the music editing screen 50 to "PLAYER".

Next, an example of the playback control screen will be described. The information processing apparatus 10 prepares an advance mode screen and a basic mode screen as the playback control screen. The information processing apparatus 10 displays the advance mode screen or the basic mode screen on the display 11 in accordance with a switching instruction.

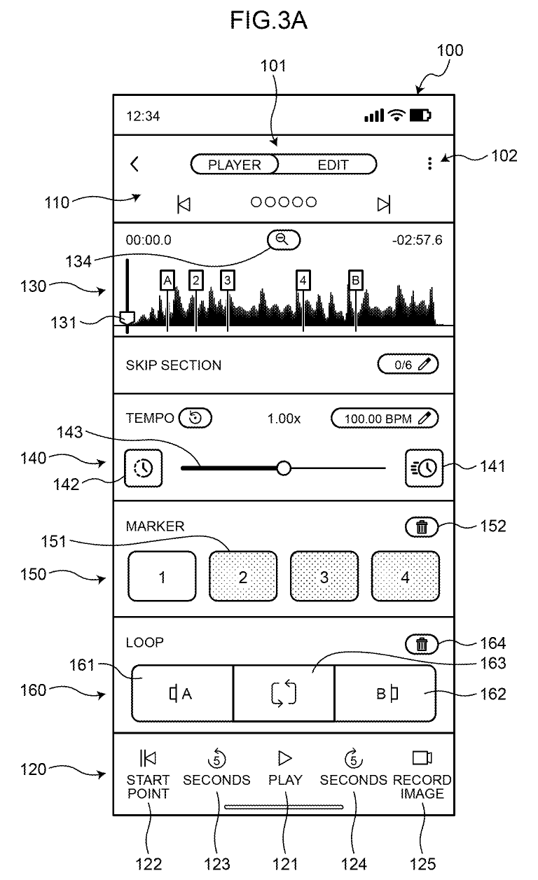

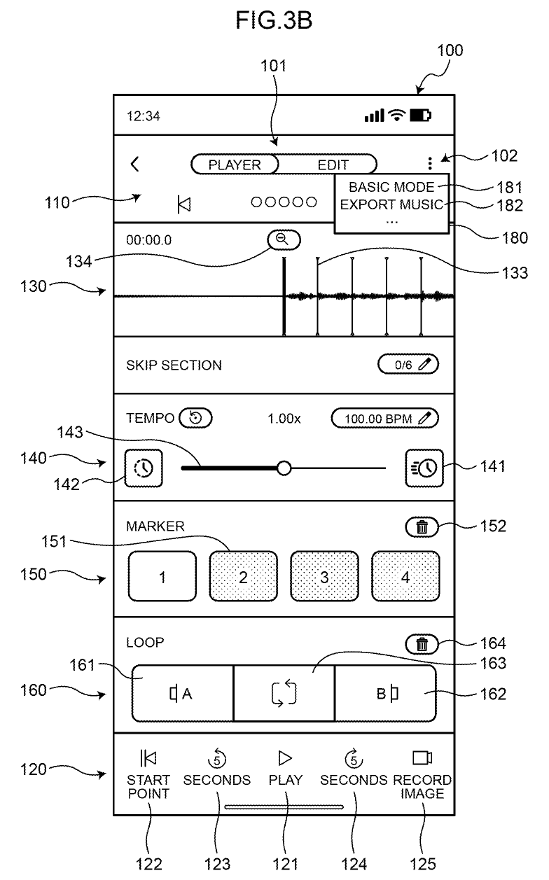

FIGS. 3A and 3B illustrate an example of an advance mode screen 100 according to the embodiment. The advance mode screen 100 includes a switching control 101, a header 110, a footer 120, a waveform display 130, a tempo operator 140, a marker operator 150, and a loop operator 160. The advance mode screen 100 can be switched to the basic mode screen through a menu button 102.

In the switching control 101, "PLAYER" and "EDIT" are displayed, and can be selected. When "PLAYER" is selected, the advance mode screen 100 is displayed. When "EDIT" is selected, the music editing screen 50 is displayed.

The header 110 displays music information such as a name of music that is played back.

The footer 120 includes a play/stop button 121, a start point button 122, a forward button 124, a back button 123, and an image recording button 125.

The play/stop button 121 is a button for giving an instruction to play back and stop playback of music. In the play/stop button 121, "PLAY" is displayed in a non-playback state in which no music is played back, and "STOP" is displayed during playback of music.

The start point button 122 is a button for giving an instruction to return a playback position to the beginning of music. The forward button 124 is a button for giving an instruction to set forward the playback position of music to predetermined seconds later. The back button 123 is a button for giving an instruction to set back the playback position of music to predetermined seconds ago. The predetermined seconds can be designated through a setting screen (not illustrated). In the present embodiment, a case where the predetermined seconds are set to five seconds is described.

The image recording button 125 is a button for giving an instruction to capture a moving image. The moving-image capturing will be described later.

The waveform display 130 displays an audio waveform indicating a change in audio of the entire music along a timeline of the music. Furthermore, the waveform display 130 displays a seek bar 131 at the current playback position on the timeline. Furthermore, the waveform display 130 displays a playback time and a remaining time at the playback position of the music. The seek bar 131 is slidable. When the seek bar 131 slides, the waveform display 130 receives a change of the playback position of the music.

The tempo operator 140 displays a numerical value of beats per minute (BPM) representing the tempo of music. Furthermore, the tempo operator 140 includes a tempo-up button 141, a tempo-down button 142, and a slider bar 143. The tempo-up button 141 gives an instruction to perform tempo-up of music. The tempo-down button 142 gives an instruction to perform tempo-down of music. The slider bar 143 receives a change in tempo of music by slide movement. The tempo operator 140 receives a change in playback speed of music by changing the tempo of the music through the tempo-up button 141, the tempo-down button 142, and the slider bar 143.

The marker operator 150 displays numerical values of "1" to "4" as four markers 151. When a touch operation is performed on a marker 151 during playback of music, a playback position at the timing of the touch operation is registered in the marker 151. When a touch operation is performed on the marker 151 in which the playback position has been registered, the music is played back from the playback position registered in the marker 151 on which the touch operation has been performed. In the example of FIG. 3A, a playback position is not registered in a marker 151 of "1". Playback positions have been registered in markers 151 of "2" to "4". The waveform display 130 displays, on the timeline, numerical values of "2" to "4" indicating playback positions of the markers 151 of "2" to "4". When a touch operation is performed on a marker 151, the marker operator 150 receives registration of the playback position of music and designation of the playback position. Furthermore, the marker operator 150 displays a trash box button 152. When a touch operation is performed on a marker 151 after a touch operation is performed on the trash box button 152, the playback position registered in the marker 151 is deleted.

The loop operator 160 includes a start position button 161, an end position button 162, and a loop button 163. The start position button 161 is used to designate the start position of loop playback. The end position button 162 is used to designate the end position of loop playback. The loop button 163 is used to designate loop playback. When a touch operation is performed on the start position button 161 during playback of music, a playback position at the timing of the touch operation is registered in the start position button 161 as a start position. Furthermore, when a touch operation is performed on the end position button 162 during playback of music after the start position, a playback position at the timing of the touch operation is registered in the end position button 162. A touch operation switches the loop button 163 between a selected state and a non-selected state. When music is played back with the loop button 163 being selected, loop playback is performed between the start position registered in the start position button 161 and the end position registered in the end position button 162. In the example of FIG. 3A, the waveform display 130 displays, on the timeline, "A" indicating the start position of a loop and "B" indicating the end position of loop playback. When touch operations are performed on the start position button 161, the end position button 162, and the loop button 163, the loop operator 160 receives registration of the start position and the end position of the loop playback and designation of the loop playback. The loop operator 160 displays a trash box button 164. When touch operations are performed on the start position button 161 and the end position button 162 after a touch operation is performed on the trash box button 164, the loop operator 160 deletes the playback position registered in the start position button 161 and the end position button 162.

Furthermore, a switching button 132 is provided on the waveform display 130. The switching button 132 is used to give an instruction to enlarge and display an audio waveform. When the switching button 132 is selected, the waveform display 130 enlarges and displays the audio waveform.

FIG. 3B illustrates an example of a result obtained by selecting the switching button 132 in FIG. 3A. As illustrated in FIG. 3B, the waveform display 130 displays an audio waveform of music within a predetermined time before and after the current playback position, which is the center of the predetermined time. Furthermore, the waveform display 130 plots a beat grid 133 in accordance with beat positions of the music. A switching button 134 is provided on the waveform display 130. The switching button 134 is used to give an instruction to entirely display the audio waveform. When the switching button 134 is selected, returning to FIG. 3A is performed. The waveform display 130 displays the audio waveform of the entire music.

The menu button 102 is provided in the advance mode screen 100. In the menu button 102, three dots are vertically aligned on the right of the switching control 101. When the menu button 102 is selected, a menu 170 is displayed. A switching button 181 and an export button 182 are provided in a menu 180. The switching button 181 is used to give an instruction to perform switching to the basic mode screen. The export button 182 is used to give an instruction to export music as an audio file. When the display 11 displays the basic mode screen as the playback control screen, the switching button 181 is selected.

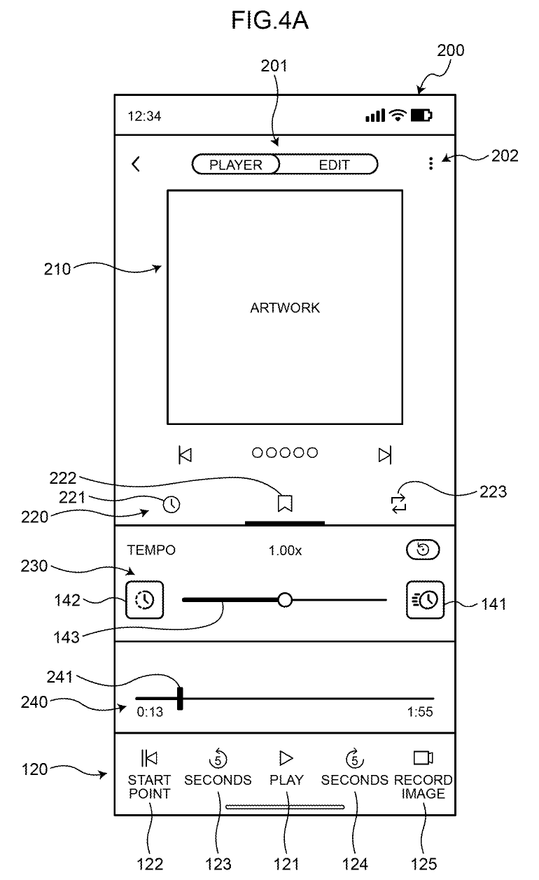

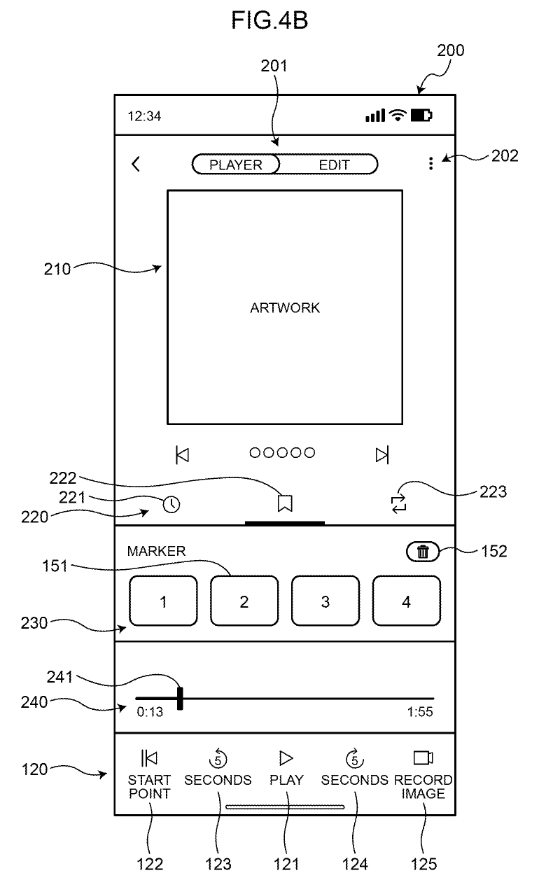

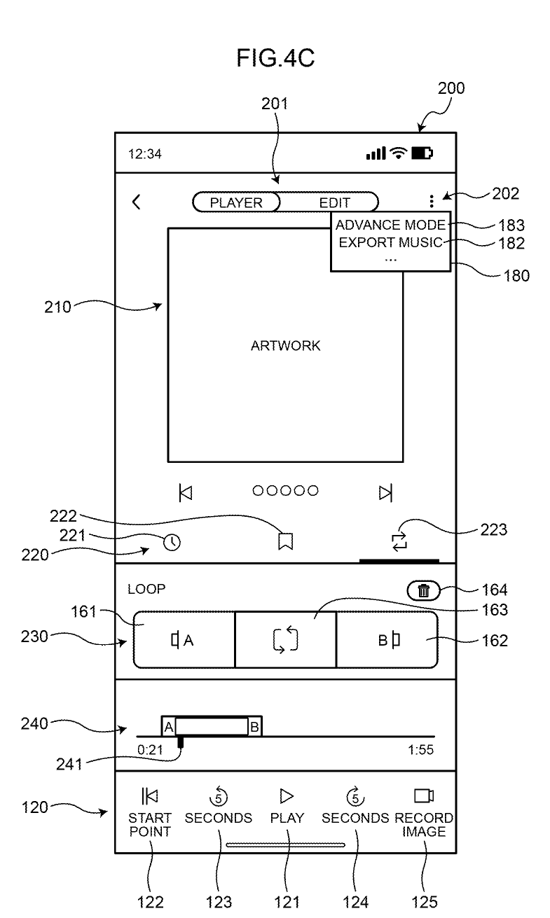

FIGS. 4A to 4C illustrate an example of a basic mode screen 200 according to the embodiment. The basic mode screen 200 includes the footer 120, a switching control 201, an artwork display 210, a tag unit 220, an operator 230, and a timeline display 240. The basic mode screen 200 can be switched to the advance mode screen 100 through the menu button 102.

In the switching control 201, "PLAYER" and "EDIT" are displayed, and can be selected. When "PLAYER" is selected, the basic mode screen 200 is displayed. When "EDIT" is selected, the music editing screen 50 is displayed.

The artwork display 210 displays artwork such as an album cover of music. For example, when a plurality of pieces of music is connected on the music editing screen 50 to compose music, the artwork display 210 displays artwork of the music at a playback position.

The tag unit 220 includes a tempo 221, a marker 222, and a loop 223 as tags. Display of the operator 230 is switched through a tag selected in the tag unit 220.

FIG. 4A illustrates a state in which the tempo 221 is selected by the tag unit 222. When the tempo 221 is selected, the operator 230 functions as the tempo operator 140 of the above-described advance mode screen 100. The tempo-up button 141, the tempo-down button 142, and the slider bar 143 are displayed. The operator 230 receives a change in playback speed of music by changing the tempo of the music through the tempo-up button 141, the tempo-down button 142, and the slider bar 143.

FIG. 4B illustrates a state in which the marker 222 is selected in the tag unit 220. When the marker 222 is selected, the operator 230 functions as the marker operator 150 of the above-described advance mode screen 100. The numerical values of "1" to "4" are displayed as the four markers 151. When a touch operation is performed on the marker 151, the operator 230 receives registration of the playback position of music and designation of the playback position. Furthermore, the operator 230 displays the trash box button 152. When a touch operation is performed on a marker 151 after a touch operation is performed on the trash box button 152, the playback position registered in the marker 151 is deleted.

FIG. 4C illustrates a state in which the loop 223 is selected in the tag unit 220. When the loop 223 is selected, the operator 230 functions as the loop operator 160 of the above-described advance mode screen 100. The start position button 161, the end position button 162, and the loop button 163 are displayed. When touch operations are performed on the start position button 161, the end position button 162, and the loop button 163, the operator 230 receives registration of the start position and the end position of the loop playback and designation of the loop playback. The operator 230 displays the trash box button 164. When touch operations are performed on the start position button 161 and the end position button 162 after a touch operation is performed on the trash box button 164, the operator 230 deletes the playback position registered in the start position button 161 and the end position button 162.

The timeline display 240 displays a timeline of music, and displays a seek bar 241 at the current playback position on the timeline. Furthermore, the timeline display 240 displays a playback time at a playback position of music and the playback time of the entire music. When a playback position is registered in a marker 151 and the start position and the end position of loop playback are registered, the timeline display 240 displays start positions on the timeline. FIG. 4C displays "A" indicating the start position of a loop and "B" indicating the end position of loop playback.

A menu button 202 is provided in the basic mode screen 200. In the menu button 202, three dots are vertically aligned on the right of the switching control 201. When the menu button 202 is selected, a menu 270 is displayed. A switching button 183 and the export button 182 are provided in the menu 180. The switching button 183 is used to give an instruction to perform switching to the advance mode screen 100. The export button 182 is used to give an instruction to export music as an audio file. When the display 11 displays the advance mode screen 100 as the playback control screen, the switching button 183 is selected.

A tempo at which music is played back and a playback condition at the time when the music is played back, such as loop playback, are set in the advance mode screen 100 and the basic mode screen 200.

The description is returned to FIG. 1. The display control unit 16a performs control of displaying the music editing screen 50 on the display 11 in response to an operation. Furthermore, the display control unit 16a performs control of displaying the advance mode screen 100 or the basic mode screen 200 on the display 11 as the music editing screen in response to an operation.

The editing unit 16b edits music in accordance with an operation to the music editing screen 50. The editing unit 16b stores, in the storage unit 15, data on music edited on the music editing screen 50 as the project data 15a. For example, the editing unit 16b stores data on music registered in a track 81 in the project data 15a for each track 81 of the music editing screen 50. Furthermore, when music is edited on the music editing screen 50, the editing unit 16b stores data indicating the edit contents in the project data 15a. For example, when a part of music is cut out and extracted, the editing unit 16b stores data on the extracted part of the music in the project data 15a. Furthermore, when edit of adding an effect to music is performed, the editing unit 16b stores data on the added effect in the project data 15a. For example, when fade-in is added to music, the editing unit 16b stores, in the project data 15a, data indicating the position of the start point and the position of the end point of the fade-in in the music and indicating that fade-in is to be performed in the music. This causes the storage unit 15 to store the music edited by the editing unit 16b and the edit contents in the project data 15a.

When an instruction to play back music is given through the play/stop button 121, the playback unit 16c starts to play music edited through the music editing screen 50. The playback unit 16c plays the music under a playback condition of the playback control screen. Playing music under a playback condition of the playback control screen means that the playback unit 16c plays music before the music is exported in a specific format. For example, the playback unit 16c plays music stored in the project data 15a under a playback condition set in the advance mode screen 100 or the basic mode screen 200. For example, the playback unit 16c plays music stored in the project data 15a at a tempo set in the advance mode screen 100 or the basic mode screen 200. The playback unit 16c plays a plurality of pieces of music of tracks stored in the project data 15a in the order of playback positions in reflection of an effect stored in the project data 15a. When loop playback is designated in the advance mode screen 100 or the basic mode screen 200, the playback unit 16c performs loop playback of music from the start position to the end position of the loop playback.

The moving-image capturer unit 16d controls the camera unit 14, and captures a moving image in response to a capturing instruction. For example, when a touch operation is performed on the image recording button 125 of the footer 120 on the advance mode screen 100 or the basic mode screen 200, the display control unit 16a performs control of displaying a moving-image capturing screen on the display 11.

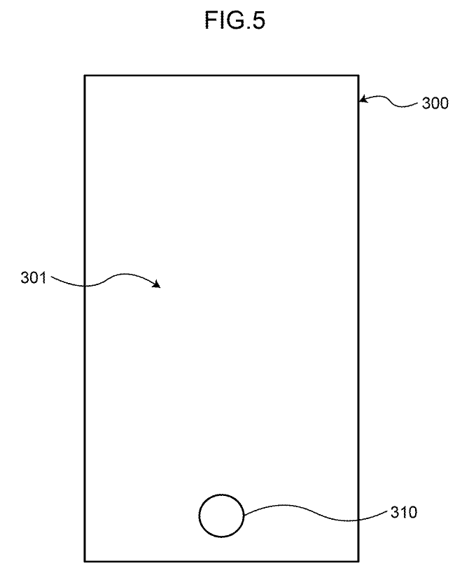

FIG. 5 illustrates an example of a moving-image capturing screen 300 according to the embodiment. The moving-image capturing screen 300 includes a video display region 301 and a capturing button 310.

A live view is displayed in the video display region 301. For example, when a touch operation is performed on the image recording button 125, the moving-image capturer unit 16d controls the camera unit 14, and captures a moving image. For example, the moving-image capturer unit 16d controls the camera unit 14, and captures an image at a predetermined frame rate as a moving image. The moving image captured by the camera unit 14 is displayed as a live view in the video display region 301.

The capturing button 310 is a button used to give an instruction to start and end moving-image capturing.

When a touch operation is performed on the capturing button 310, the playback unit 16c starts to play music edited through the music editing screen 50. The playback unit 16c plays the music under a playback condition of the playback control screen. For example, the playback unit 16c plays music stored in the project data 15a under a playback condition set in the advance mode screen 100 or the basic mode screen 200. For example, the playback unit 16c plays music stored in the project data 15a at a tempo set in the advance mode screen 100 or the basic mode screen 200. The playback unit 16c plays a plurality of pieces of music of tracks stored in the project data 15a in the order of playback positions in reflection of an effect stored in the project data 15a. When loop playback is designated on the advance mode screen 100 or the basic mode screen 200, the playback unit 16c performs loop playback of music from the start position to the end position of the loop playback.

When a touch operation is performed on the capturing button 310, the moving-image capturer unit 16d captures a moving image containing, as audio, music that is played back by the playback unit 16c, and stores, in the storage unit 15, the captured moving image as moving-image data in a predetermined moving-image file format. Examples of the moving-image file format include Moving Picture Experts Group phase 4 (MPEG-4), M4V, and MOV.

The generating unit 16e generates audio data in a predetermined audio file format from the project data 15a stored in the storage unit 15 in response to an export instruction given to the operation screen. Examples of the audio file format include MPEG Audio Layer-3 (MP3) and Advanced Audio Coding (AAC). For example, when a touch operation is performed on the export button 182 in the menu 180 on the advance mode screen 100 or the basic mode screen 200, the generating unit 16e generates audio data in a predetermined audio file format from the project data 15a. The generating unit 16e stores the generated audio data in the storage unit 15.

Next, an example in which a user involved in a dance, such as a dancer, uses the information processing apparatus 10 according to the embodiment will be described. First, an example of a flow in which the user edits music to be used for a dance and captures a moving image of his/her dancing in accordance with the edited music will be described.

The user registers music in a track 81 on the music editing screen 50, and edits the music by using the music editing screen 50. For example, the user adds an effect to the music, and changes the length of the music. The editing unit 16b stores, in the storage unit 15, data on music edited on the music editing screen 50 as the project data 15a.

When practicing a dance in accordance with music, the user changes the tempo of the music, plays back the music from a specific part of the music, and repeatedly plays back a specific part by using the advance mode screen 100 or the basic mode screen 200. The playback unit 16c plays music stored in the project data 15a under a playback condition set in the advance mode screen 100 or the basic mode screen 200.

When capturing a moving image of the user dancing in accordance with the edited music, the user selects the image recording button 125 from the advance mode screen 100 or the basic mode screen 200 to display the moving-image capturing screen 300, and performs a touch operation on the capturing button 310. The playback unit 16c plays music stored in the project data 15a under a playback condition set in the advance mode screen 100 or the basic mode screen 200. The moving-image capturer unit 16d captures a moving image containing, as audio, music that is played back by the playback unit 16c, and stores, in the storage unit 15, the captured moving image as moving-image data in a predetermined moving-image file format.

As described above, the information processing apparatus 10 can capture a moving image by using an edited music before the edited music is exported in an audio file format.

Next, an example of a flow in which the user repeats music edit and moving-image capturing will be described. The user checks a captured moving image, and repeats reviewing the choreography of a dance and editing music, as necessary. For example, the user re-edits the music by using the music editing screen 50. Then, the user captures a moving image of his/her dancing in accordance with the re-edited music. For example, the user captures the moving image by using the moving-image capturing screen 300.

The information processing apparatus 10 displays the music editing screen 50 by selecting "EDIT" with the switching control 101 on the advance mode screen 100 or the switching control 201 on the basic mode screen 200. This enables the user to easily re-edit the music by using the music editing screen 50. When capturing a moving image of the user dancing in accordance with the re-edited music, the user displays the moving-image capturing screen 300, and performs a touch operation on the capturing button 310. When a touch operation is performed on the capturing button 310, the information processing apparatus 10 captures a moving image containing, as audio, the re-edited music, and stores, in the storage unit 15, the captured moving image as moving-image data in a predetermined moving-image file format.

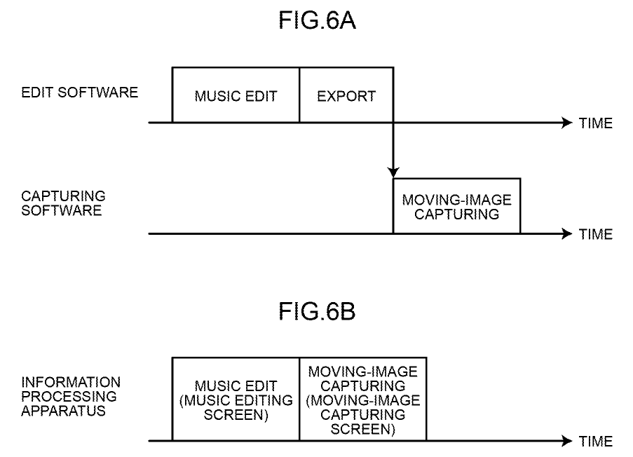

FIG. 6A and FIG. 6B illustrates an example of a flow in which the user edits music and captures a moving image. FIG. 6A illustrates, in chronological order, an example of a flow in which the user edits music by using edit software as before and captures a moving image by using capturing software. FIG. 6B illustrates, in chronological order, an example of a flow in which the user edits music by using the information processing apparatus 10 according to the embodiment and captures a moving image.

When using edit software and capturing software as before, as illustrated in FIG. 6A, the user edits music by using the edit software, and exports and stores the edited music as audio data in an audio file format by using the edit software. If the music edited by using the edit software is not exported and stored as audio data in an audio file format such as MP3, the music cannot be played back by other software. Therefore, the user exports and stores the edited music as audio data in an audio file format by using the edit software. When capturing a moving image, the user captures a moving image by using the capturing software while playing back the stored audio data by using other software having a playback function. The other software having a playback function may be capturing software.

As described above, when the edit software and the capturing software are used, the user needs to export and store the edited music as audio data in an audio file format, and captures a moving image while playing back the stored audio data, which takes time and effort.

The user exports the edited music, and captures a moving image. Then, for example, when the music does not match the moving image, the user re-edits and exports the music, and repeats capturing a moving image. In the audio data in an audio file format, audio of the edited music is recorded. The user cannot re-edit the music without using the edit software. Therefore, when music re-edit and moving-image capturing are repeated, the user re-edits the music by using the edit software, and exports and stores the re-edited music as audio data in an audio file format by using the edit software. Then, the user captures a moving image by using the capturing software while playing back the stored audio data by using other software.

As described above, when music re-edit and moving-image capturing are repeated, the user exports and stores a re-edited music again for each re-edit as audio data in an audio file format, and captures a moving image, which takes time and effort.

In contrast, when music edit and moving-image capturing are performed by using the information processing apparatus 10 according to the embodiment, the user edits the music by using the music editing screen 50 as illustrated in FIG. 6B. Then, the user switches a screen to the moving-image capturing screen 300, and captures a moving image by using the edited music.

The information processing apparatus 10 stores, in the storage unit 15, music edited through the music editing screen 50 as the project data 15a. When a moving image is captured through the moving-image capturing screen 300, the information processing apparatus 10 captures a moving image while playing back an edited music stored in the project data 15a. As described above, the information processing apparatus 10 can edit music through the music editing screen 50. The information processing apparatus 10 can capture a moving image by using the edited music through the moving-image capturing screen 300 before the music is exported in an audio file format. This enables the information processing apparatus 10 to reduce a load in a case where the user edits music and captures a moving image.

The user captures a moving image by using the edited music. Then, for example, when the music does not match the moving image, the user re-edits the music, and repeats capturing a moving image. When music re-edit and moving-image capturing are repeated, the user switches the screen to the music editing screen 50, and re-edits the music. In the re-edit, the music and the edit contents stored in the project data 15a are displayed on the music editing screen 50. The user can re-edit music that has been once edited through the music editing screen 50. The re-edit includes adding an effect to the music and changing the length of the music. The user switches the screen to the moving-image capturing screen 300, and captures a moving image by using the re-edited music.

The information processing apparatus 10 stores, in the storage unit 15, music re-edited through the music editing screen 50 as the project data 15a, and plays the re-edited music stored in the project data 15a when a moving image is captured. As described above, the information processing apparatus 10 can re-edit music through the music editing screen 50. The information processing apparatus 10 can capture a moving image by using the re-edited music through the moving-image capturing screen 300 before the re-edited music is exported in an audio file format even when the music is re-edited. This enables the information processing apparatus 10 to reduce a load in a case where the user repeats music re-edit and moving-image capturing.

When the music edited through the music editing screen 50 is exported as an audio file, the user performs a touch operation on the export button 182 in the menu 180 on the advance mode screen 100 or the basic mode screen 200. When a touch operation is performed on the export button 182, the generating unit 16e generates audio data in a predetermined audio file format from the project data 15a, and stores the generated audio data in the storage unit 15.

Since being in an audio file format, the audio data stored in the storage unit 15 can be played back by another device. This enables the user to play back the music edited through the music editing screen 50 with another device by copying or moving the audio data stored in the storage unit 15 to the other device.

### Flow of Processing

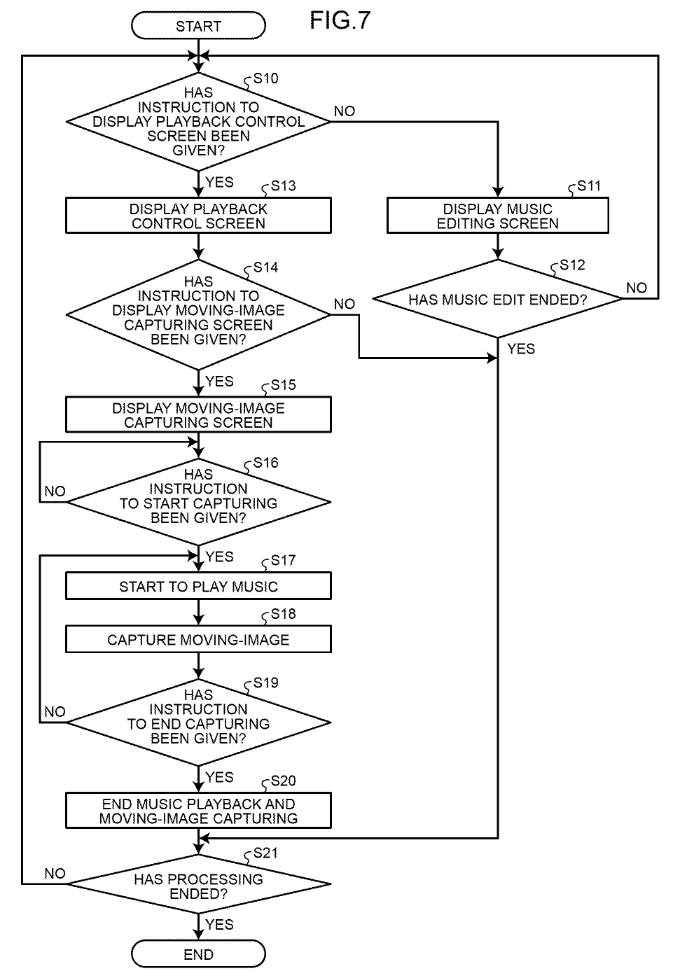

Next, a flow of control processing including music playback processing of the information processing apparatus 10 according to the embodiment will be described. FIG. 7 is a flowchart illustrating an example of a procedure of the control processing including the music playback processing according to the embodiment. The music playback processing in FIG. 7 is performed at the timing when a touch operation is performed on the capturing button 310 of the moving-image capturing screen 300 and an instruction to start to capture a moving image is given.

The display control unit 16a determines whether or not an instruction to display the playback control screen has been given (Step S10). For example, when "PLAYER" is selected in the switching controls 51, 101, and 201, the display control unit 16a determines that the instruction to display the playback control screen has been given.

When the instruction to display the playback control screen has not been given (Step S10: No), "EDIT" is selected in the switching controls 51, 101, and 201. Therefore, the display control unit 16a performs control of displaying the music editing screen 50 (Step S11). The editing unit 16b edits music in accordance with an operation to the music editing screen 50. The editing unit 16b stores, in the storage unit 15, data on music edited in the music editing screen 50 as the project data 15a.

When music edit on the music editing screen 50 has not been completed (Step S12: No), the display control unit 16a shifts to Step S10 above. When the music edit on the music editing screen 50 has been completed (Step S12: Yes), the display control unit 16a shifts to Step S21 to be described later.

In contrast, when an instruction to display the playback control screen is given (Step S10: Yes), the display control unit 16a performs control of displaying the advance mode screen 100 or the basic mode screen 200 as the music editing screen (Step S13). The advance mode screen 100 and the basic mode screen 200 receive setting of a playback condition in playing back music. When an instruction to play back music is given through the play/stop button 121, the playback unit 16c plays music stored in the project data 15a under the playback condition set in the advance mode screen 100 or the basic mode screen 200.

The display control unit 16a determines whether or not an instruction to display the moving-image capturing screen has been given (Step S14). For example, when the image recording button 125 is selected on the advance mode screen 100 or the basic mode screen 200, the display control unit 16a determines that the instruction to display the moving-image capturing screen has been given. When the instruction to display the moving-image capturing screen has not been given (Step S14: No), the processing shifts to Step S21 to be described later.

In contrast, when the instruction to display the moving-image capturing screen has been given (Step S14: Yes), the display control unit 16a performs control of displaying the moving-image capturing screen 300 (Step S15).

The moving-image capturer unit 16d determines whether or not an instruction to start to capture a moving image has been given (Step S16). For example, when a touch operation is performed on the capturing button 310 in the moving-image capturing screen 300, the moving-image capturer unit 16d determines that the instruction to start to capture a moving image has been given. When the instruction to start to capture a moving image has not been given (Step S16: No), the processing shifts to Step S15 again, and the start instruction is awaited.

When the instruction to start to capture a moving image has been given (Step S16: Yes), the playback unit 16c starts to play music edited through the music editing screen 50 under a playback condition of the playback control screen (Step S17). For example, the playback unit 16c plays music stored in the project data 15a under a playback condition set in the advance mode screen 100 or the basic mode screen 200.

The moving-image capturer unit 16d captures a moving image containing, as audio, music that is played back by the playback unit 16c (Step S18).

The moving-image capturer unit 16d determines whether or not an instruction to end capturing has been given (Step S19). For example, when a touch operation is performed on the capturing button 310 in the moving-image capturing screen 300 after the start of moving-image capturing, the moving-image capturer unit 16d determines that the instruction to end capturing has been given. When the instruction to end capturing has not been given (Step S19: No), the processing shifts to Step S17, and the moving-image capturing is continued.

In contrast, when the instruction to end capturing has been given (Step S19: Yes), the playback unit 16c ends playback of the music. The moving-image capturer unit 16d ends moving-image capturing, and stores, in the storage unit 15, the captured moving image as moving-image data in a predetermined moving-image file format (Step S20).

The display control unit 16a determines whether or not to end the processing (Step S21). For example, when a predetermined operation for giving an instruction to end the processing is performed, the display control unit 16a determines to end the processing (Step S21: Yes), and ends the processing. In contrast, when the instruction to end the processing has not been given (Step S21: No), the processing shifts to Step S10 above.

### Conclusion

As described above, the information processing apparatus 10 according to the embodiment plays music edited through the music editing screen 50 under a playback condition of playback control screens (advance mode screen 100 and basic mode screen 200), and captures a moving image containing, as audio, the music that is played back. This enables the information processing apparatus 10 to capture a moving image by using an edited music before the edited music is exported in an audio file format.

### Second Embodiment

Although the first embodiment of the present disclosure has been described so far, various applications are possible. Furthermore, various different forms other than the above-described first embodiment may be implemented.

### Exhibition of Creation Ability

The matters described in the above-described first embodiment, for example, the screen configurations of the music editing screen 50, the advance mode screen 100, the basic mode screen 200, and the moving-image capturing screen 300 are merely examples, and can be changed. Furthermore, the edit contents of music on the music editing screen 50 are merely examples, and can be changed. Furthermore, a playback condition that can be set through the basic mode screen 200 and the moving-image capturing screen 300 is merely an example, and can be changed. Furthermore, the processing order of the flowchart described in the above-described first embodiment can be changed within a range without inconsistency.

### Application to Other Use Scene

Although, in the above-described first embodiment, an example in which the information processing apparatus 10 is a mobile terminal such as a smartphone has been described, cloud service such as a web service may provide the edit function, the playback control function, and the moving-image capturing function of the information processing apparatus 10.

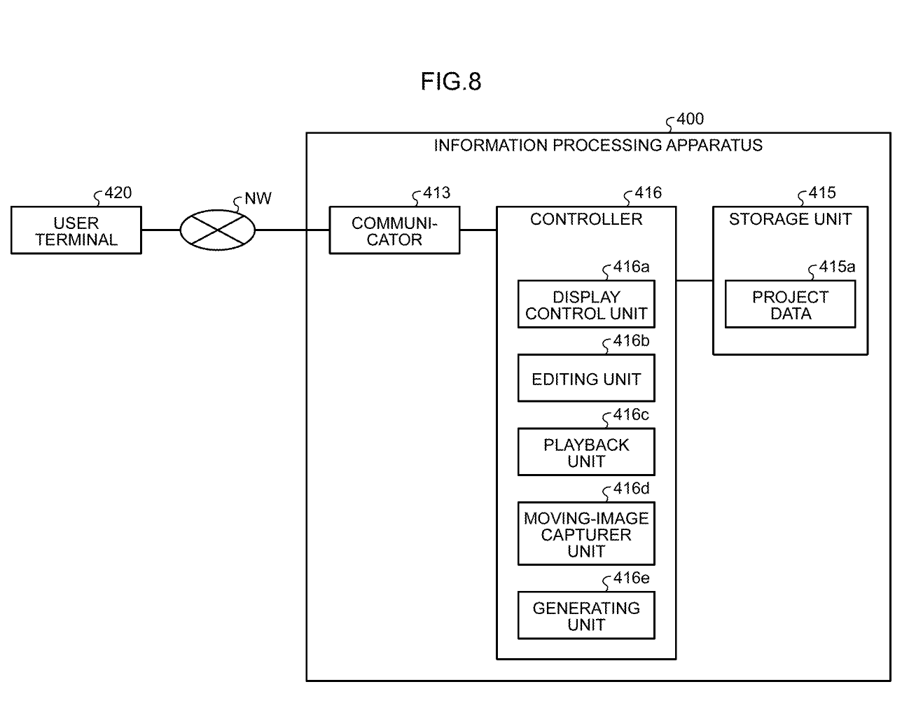

FIG. 8 is a block diagram illustrating a functional configuration example of an information processing apparatus 400 according to the embodiments. For example, FIG. 8 illustrates the information processing apparatus 400 that provides cloud service.

A server device may implement the information processing apparatus 400. For example, the information processing apparatus 400 can provide, as cloud service, the edit function, the playback control function, and the moving-image capturing function by executing middleware of platform as a service (PaaS) type or an application of software as a service (SaaS) type.

As illustrated in FIG. 8, the information processing apparatus 400 can be communicably connected to a user terminal 420 via a network NW. For example, the network NW may be any type of communication network such as the Internet and a local area network (LAN) regardless of whether the network NW is wired or wireless network.

The user terminal 420 is a terminal device used by a user who receives provision of cloud service. The user terminal 420 may be implemented by any computer such as a smartphone, a tablet terminal, a wearable terminal, and a personal computer.

In such an entire configuration, the information processing apparatus 400 in FIG. 8 is different from the information processing apparatus 10 in FIG. 1 in that various requests are received via the network NW and in that an execution result of the processing is output via the network NW.

For example, the information processing apparatus 400 transmits screen information on an operation screen including a music editing screen and a playback control screen to the user terminal 420 via a communicator 413 to cause the user terminal 420 to display the operation screen, and receives information on an operation on the operation screen from the user terminal 420 via the communicator 413. Furthermore, the information processing apparatus 400 controls a camera of the user terminal 420 via the communicator 413 to capture a moving image, and receives data on the captured moving image from the user terminal 420 via the communicator 413.

The information processing apparatus 400 provides an edit function, a playback control function, and a moving-image capturing function to the user terminal 420. For example, a display control unit 416a, an editing unit 416b, a playback unit 416c, a moving-image capturer unit 416d, and a generating unit 416e of a controller 416 of the information processing apparatus 400 may have functions similar to those of the display control unit 16a, the editing unit 16b, the playback unit 16c, the moving-image capturer unit 16d, and the generating unit 16e of the controller 16 of the information processing apparatus 10. Furthermore, project data 415a of a storage unit 415 of the information processing apparatus 400 may have a function similar to that of the project data 15a of the storage unit 15 of the information processing apparatus 10.

The information processing apparatus 400 as described above can also capture a moving image by using an edited music before the edited music is exported in an audio file format.

### System

The processing procedure, the control procedure, the specific names, and the information including various types of data and parameters in the document and the drawings can be optionally changed unless otherwise specified. For example, one or more functional units of the display control unit 16a, the editing unit 16b, the playback unit 16c, the moving-image capturer unit 16d, and the generating unit 16e of the information processing apparatus 10 may be configured by separate devices.

Furthermore, the illustrated components of the devices are functional and conceptual ones, and do not necessarily need to be physically configured as illustrated. That is, specific forms of distribution and integration of the devices are not limited to those illustrated. That is, all or parts thereof can be functionally or physically distributed and integrated in any unit in accordance with various loads, use situations, and the like. Note that each configuration may be a physical configuration.

Moreover, all or any part of processing to be performed by the illustrated devices can be implemented by a program to be executed by a hardware processor such as a micro-processing unit (MPU) and a central processing unit (CPU), or implemented as hardware based on a wired logic.

### Hardware

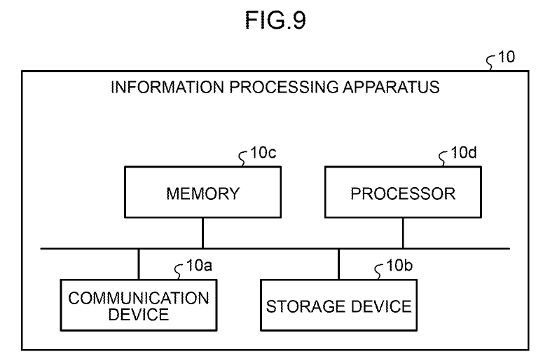

Next, a hardware configuration example of the information processing apparatuses described in the above-described embodiments will be described. FIG. 9 illustrates a hardware configuration example. As illustrated in FIG. 9, the information processing apparatus 10 includes a communication device 10a, a storage device 10b, a memory 10c, and a processor 10d. Note that the units in FIG. 9 may be connected to each other by a bus or the like.

The communication device 10a is, for example, a network interface card. The storage device 10b includes a hard disk drive (HDD) and a solid state drive (SSD). For example, the storage device 10b stores a program for operating the functions in FIG. 1 and a DB.

The processor 10d reads a program for executing processing similar to that performed by the processor in FIG. 1 from the storage device 10b and the like and loads the program in the memory 10c to operate a process for executing the functions described with reference to FIG. 1.

In the process as described above, a function similar to that of the processor of the information processing apparatus 10 is implemented. For example, the processor 10d reads, from the storage device 10b or the like, a program having functions similar to those of the display control unit 16a, the editing unit 16b, the playback unit 16c, the moving-image capturer unit 16d, the generating unit 16e, and the like. Then, the processor 10d executes a process for executing processing similar to that performed by the display control unit 16a, the editing unit 16b, the playback unit 16c, the moving-image capturer unit 16d, the generating unit 16e, and the like.

As described above, the information processing apparatus 10 implements functions similar to those in the above-described embodiments by reading and executing a program. Furthermore, the information processing apparatus 10 can implement the functions similar to those in the above-described embodiments by reading the above-described program from a recording medium with a medium reading device and executing the read program. Note that a program in another embodiment is not limited to being executed by the information processing apparatus 10. For example, also in a case where another computer or a server executes a program and in a case where the computer and the server execute the program in cooperation, the functions of the present disclosure can be similarly applied.

The above-described program can be distributed via a network such as the Internet. Furthermore, the above-described program can be executed by being recorded in any recording medium and read by the computer from the recording medium. For example, the recording medium can be implemented by a hard disk, a flexible disk (FD), a CD-ROM, a magneto-optical disk (MO), and a digital versatile disc (DVD).

According to one embodiment, a moving image can be captured by using an edited music before the edited music is exported in an audio file format.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a processor configured to:
display, on a display, an operation screen including: a music editing screen for editing music; and a playback control screen for controlling a playback condition of music;
edit music in accordance with an operation to the music editing screen;
play music edited through the music editing screen under a playback condition of the playback control screen; and
capture a moving image containing the edited music as audio while playing the edited music.

2. The information processing apparatus according to claim 1, the information processing apparatus further includes memory that stores music data of the edited music, wherein
the processor is further configured to:
generate audio data in a predetermined audio file format from music data stored in the memory in accordance with an export instruction given to the operation screen, and
play music of the music data stored in the memory.

3. The information processing apparatus according to claim 1, wherein the process is further configured to start to play music edited through the music editing screen in response to an operation for starting to capture a moving image.

4. The information processing apparatus according to claim 1, wherein
a tempo of playing music is allowed to be set as the playback condition on the playback control screen, and
the process is further configured to play back the music at a tempo set on the playback control screen.

5. The information processing apparatus according to claim 1, wherein edit of adding an effect to music is possible on the music editing screen.

6. The information processing apparatus according to claim 1, wherein edit of extracting parts of one or a plurality of pieces of music and connecting together the parts that have been extracted is possible on the music editing screen.

7. The information processing apparatus according to claim 1, wherein an audio waveform of music as a whole is displayed, and edit of designating a start point and an end point to the audio waveform and adding fade-in and fade-out to the music is possible on the music editing screen.

8. The information processing apparatus according to claim 1, wherein edit of connecting a plurality of pieces of music together is possible on the music editing screen.

9. The information processing apparatus according to claim 1, wherein edit of mixing a plurality of pieces of music is possible on the music editing screen.

10. A non-transitory computer-readable recording medium having stored therein a music playback program that causes a computer to execute a process comprising:
playing music edited through a music editing screen for editing music under a playback condition of a playback control screen for controlling a playback condition of music; and
capturing a moving image containing, as audio, the edited music that is played back.
